(19) United States
(12) Patent Application Publication
(10) Pub. No.: US 2021/0368672 A1
(43) Pub. Date: Dec. 2, 2021

(54) Fertilizing Device

(71) Applicant: SHIN TAI SPURT WATER OF THE GARDEN TOOLS CO., LTD, CHANG-HUA HSIEN (TW)

(72) Inventor: Chin-Yuan Chen, CHANG-HUA HSIEN (TW)

(21) Appl. No.: 16/890,838

(22) Filed: Jun. 2, 2020

(51) Int. Cl. A01C 23/02; A01C 15/00

(52) U.S. Cl. CPC A01C 23/02; A01C 15/00

(57) ABSTRACT

A fertilizing device has at least one of the tubular body, and the tubular body is inserted in the soil in which the plant is planted. The tubular body has a containment space inside and a plurality of through holes on its surface. The tubular body is provided with at least first separated section at its top, and a number of second separated sections among the through holes. When the tubular body is inserted into the soil around the plant, the first separated section of the tubular body is exposed, and the second separated sections are configured for adjusting the spacing between the through holes. When the fertilizer and moisture are introduced into the containment space through the top of the tubular body, the fertilizer and moisture are discharged through the through holes of the tubular body, so that the fertilizer and water can penetrate into the deeper soil more evenly and the plant roots and soil can absorb nutrients and water more completely.

### BACKGROUND OF INVENTION

### Field of Invention

The present invention relates to a fertilizing device, and more particularly to a fertilizing device capable of thoroughly distribution.

### Description of Related Art

When plants are planted, fertilizer is usually sprinkled on the surface of the soil to provide plant nutrients, maintain the fertility of the soil, improve plant growth quality, and enable plants to grow more abundantly.

However, the above planting method, it is not efficient because the plant system absorbs nutrients through its roots and the fertilizer on the soil surface fertilizer must be dissolved and penetrated into the soil by water flow to be fully absorbed by the soil. Therefore, the deeper plant roots can absorb less nutrients than the plant roots near the soil surface, and the roots cannot absorb nutrients completely.

Therefore, it is desirable to provide a fertilizing device to mitigate and/or obviate the aforementioned problems.

### SUMMARY OF INVENTION

An objective of present invention is to provide a fertilizing device, which is capable of improving the above-mention problems.

In order to achieve the above mentioned objective, a fertilizing device has at least one of the tubular body, and the tubular body is inserted in the soil in which the plant is planted. The tubular body has a containment space inside and a plurality of through holes on its surface. The tubular body is provided with at least first separated section at its top, and a number of second separated sections among the through holes. When the tubular body is inserted into the soil around the plant, the first separated section of the tubular body is exposed, and the second separated sections are configured for adjusting the spacing between the through holes. When the fertilizer and moisture are introduced into the containment space through the top of the tubular body, the fertilizer and moisture are discharged through the through holes of the tubular body, so that the fertilizer and water can penetrate into the deeper soil more evenly and the plant roots and soil can absorb nutrients and water more completely.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment of the present invention.

FIG. 2 is a schematic drawing of the tubular body being inserted in the soil according to the preferred embodiment of the present invention.

FIG. 3 is a schematic drawing of the tubular body being inserted in the soil and the fertilizer being introduced from the top of the tubular body according to the preferred embodiment of the present invention.

FIG. 4 is a schematic drawing of the tubular body being inserted into the soil and the through holes of the tubular body disturbing the fertilizer according to the preferred embodiment of the present invention.

FIG. 5 is a schematic drawing of the tubular body being inserted in the soil at both sides of the plant according to the preferred embodiment of the present invention.

FIG. 6 is a cross-sectional view of the tubular body being inserted in the soil at both sides of the plant according to the preferred embodiment of the present invention.

FIG. 7 is another schematic drawing of the tubular body being inserted in the soil according to the preferred embodiment of the present invention.

### DETAILED DESCRIPTION OF PREFERRED EMBODIMENT

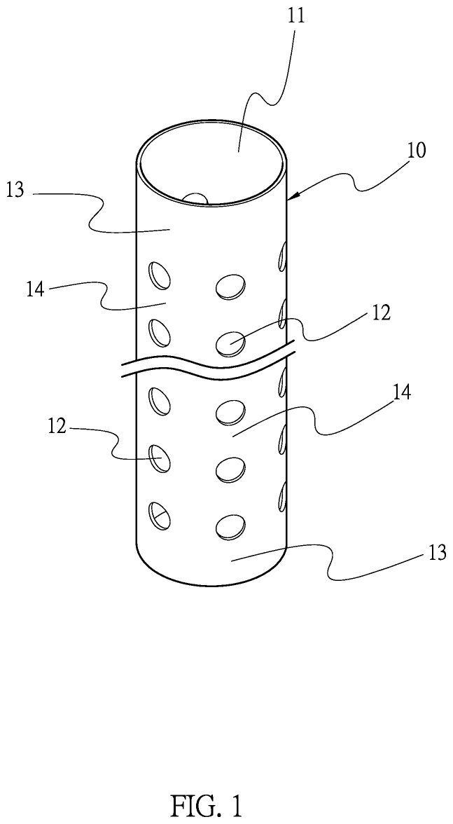

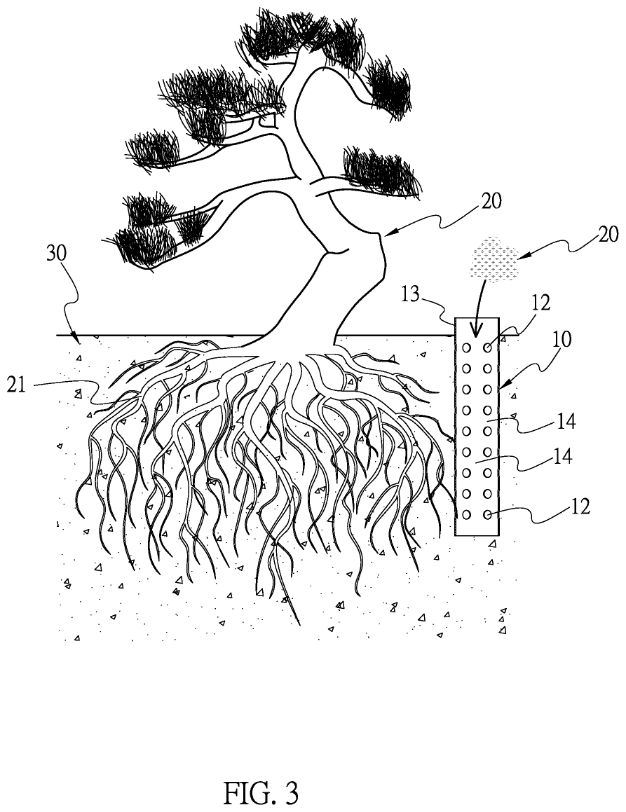

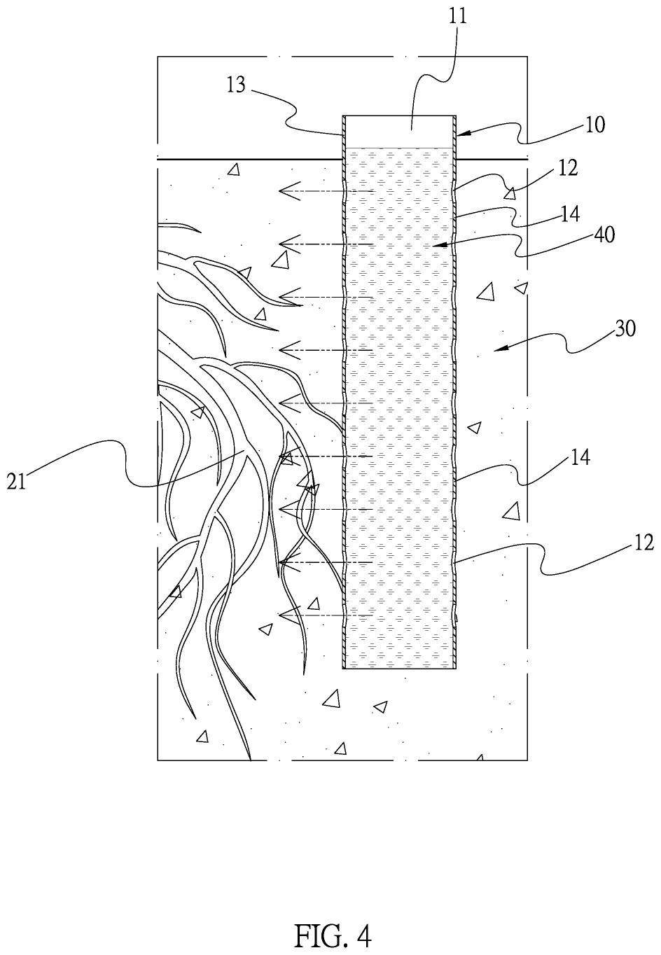

First, please refer to FIGS. 1, 3 and 4. A fertilizing device comprises at least one tubular body 10 for insertion into soil 30 with plants 20. The tubular body 10 has a containment space 11 with a plurality of through holes 12 and the tubular body 10 provided with at least one first separated section 13 and a plurality of second separated sections 14 among the through holes 12. The containment space 11 is configured for accepting fertilizer 40 and the through holes 12 are configured for disturbing fertilizer 40 and moisture. The first separated section 13 is exposed from the soil 20 containing the tubular body 10, and the second separated sections 14 are configured for adjusting distances between the through holes 12.

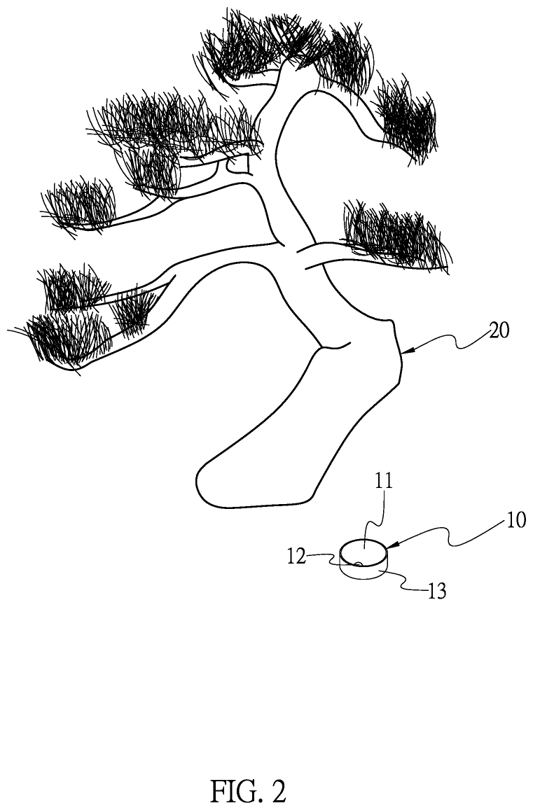

Please refer to FIGS. 2 to 4. During a real application, the fertilizer 40 and moisture are filled in the containment space 11 through the top of the tubular body 10, and the through holes 12 of the tubular body 10 distribute the fertilizer 40 and water which allows the fertilizer 40 and water to penetrate more evenly into deeper soil 30, so that deeper roots 21 of plant 20 and soil 30 can absorb nutrients and water more completely.

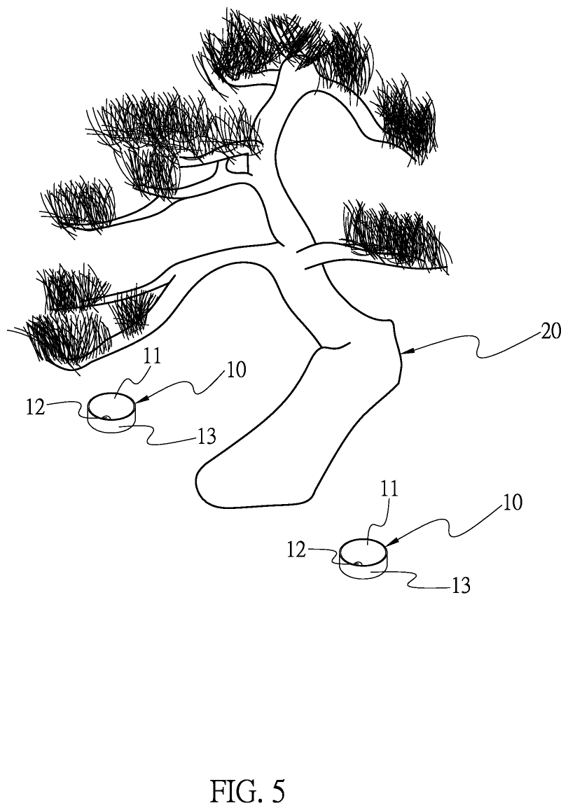

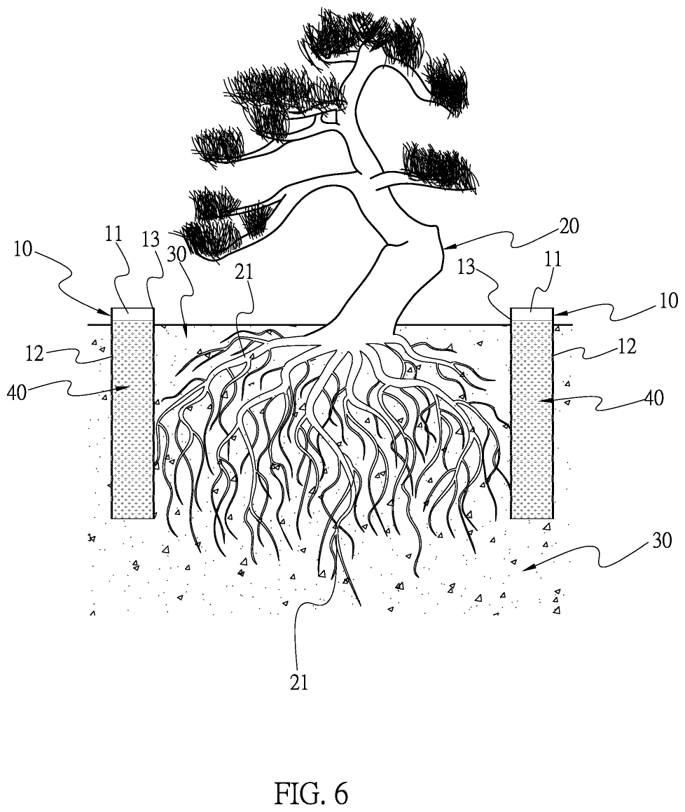

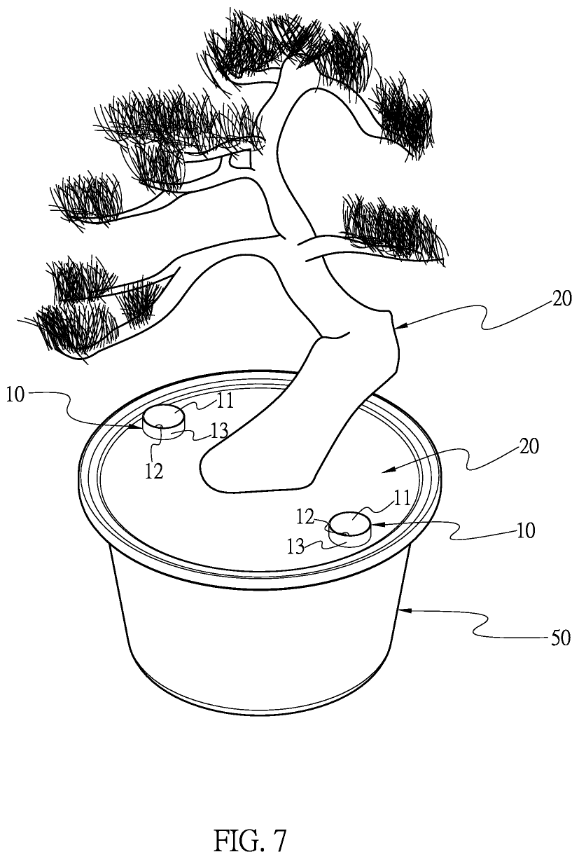

Please refer to FIGS. 5-7, the several tubular bodies 10 can be inserted in the soil 30 around the roots 21 of the plant 20, so that the roots 21 of the plant 20 can absorb nutrients more evenly. Also, the plant 20 can be planted in the pot 50, the tubular body 10 is inserted into the soil 30 in the pot 50, so that the nutrients and water are concentrated in the soil 30 in the pot 50 without nutrient loss.

Furthermore, the tubular body 10 is a plastic tubular body.

Moreover, according to the present invention, a length of the tubular body 10 is adjustable.

In addition, according to the present invention, the through holes 12 have different shapes.

Also, according to the present invention, positions of the through holes 12 are adjustable.
Furthermore, according to the present invention, distances among the second separated sections 14 are equal.

Also, according to the present invention, distances among the second separated sections 14 are different.

In addition, according to the present invention, sizes of the through holes 12 are modifiable.

Moreover, according to the present invention, the through holes 12 are arranged in parallel.

Additionally, according to the present invention, the through holes 12 are arranged randomly.

As well, according to the present invention, the tubular body 10 is wrapped with an internal or an external net for lowering a distribution speed of the fertilizer 40.

With the above structure, the tubular body 10 is inserted into the soil 30, and then the fertilizer 40 and water are filled into the containment space 11 through the top of the tubular body 10, so the through holes 12 of the tubular body 10 can exile the fertilizer 40 and water into the deeper soil 30. So the roots 21 and the soil 30 of the plant 20 can absorb nutrients and water more completely and quickly, and the quality of the deeper soil 30 becomes more solid.

Although the present invention has been explained in relation to its preferred embodiment, it is to be understood that many other possible modifications and variations can be made without departing from the spirit and scope of invention as hereinafter claimed.

What is claimed is:

1. A fertilizing device comprising at least one tubular body for insertion into soil with plants, wherein:
the tubular body has a containment space with a plurality of through holes, the tubular body provided with at least one first separated section at a top end and a plurality of second separated sections among the through holes, the containment space configured for accepting fertilizer and the through holes configured for disturbing fertilizer and moisture, the first separated section exposed from the soil containing the tubular body, and the second separated sections are configured for adjusting distances between the through holes.

2. The fertilizing device as claimed in claim 1, wherein the tubular body is a plastic tubular body.

3. The fertilizing device as claimed in claim 1, wherein a length of the tubular body is adjustable.

4. The fertilizing device as claimed in claim 1, wherein the through holes have different shapes.

5. The fertilizing device as claimed in claim 1, wherein positions of the through holes are adjustable.

6. The fertilizing device as claimed in claim 1, wherein distances among the second separated sections are equal.

7. The fertilizing device as claimed in claim 1, wherein distances among the second separated sections are different.

8. The fertilizing device as claimed in claim 1, wherein sizes of the through holes are modifiable.

9. The fertilizing device as claimed in claim 1, wherein the through holes are arranged in parallel.

10. The fertilizing device as claimed in claim 1, wherein the through holes are arranged randomly.

11. The fertilizing device as claimed in claim 1, wherein the tubular body is wrapped with an internal net for lowering a distribution speed of the fertilizer.

12. The fertilizing device as claimed in claim 1, wherein the tubular body is wrapped with an external net for lowering a distribution speed of the fertilizer.
